(19) United States
(12) Patent Application Publication
(10) Pub. No.: US 2013/0027337 A1
(43) Pub. Date: Jan. 31, 2013

(54) METHOD FOR SWITCHING TOUCH SCREEN OF MOBILE TERMINAL BETWEEN HORIZONTAL SCREEN AND VERTICAL SCREEN AND MOBILE TERMINAL

(71) Applicant: Huawei Device Co., Ltd., Shenzhen (CN)

(72) Inventor: Lei CHEN, Beijing (CN)

(73) Assignee: Huawei Device Co., Ltd., Shenzhen (CN)

(21) Appl. No.: 13/633,556

(22) Filed: Oct. 2, 2012

Related U.S. Application Data
(63) Continuation of application No. PCT/CN2010/078864, filed on Nov. 18, 2010.

(30) Foreign Application Priority Data
Apr. 8, 2010 (CN) 201010144597.9

(51) Int. Cl. G06F 3/041

(52) U.S. Cl. 345/173

(57) ABSTRACT

The present invention relates to a method for switching the touch screen of a mobile terminal between a horizontal screen and a vertical screen and a mobile terminal. The method includes: according to the value of acceleration of gravity in a direction vertical to the screen of the mobile terminal, determining whether the operation mode of the mobile terminal is a normal operation mode or a recumbent operation mode; determining, according to a determined operation mode, a criterion for switching between a horizontal screen and a vertical screen; and performing switching between a horizontal screen and a vertical screen according to the criterion. The present invention solves the problem that the user's requirement for switching between a horizontal screen and a vertical screen cannot be met when the user lies on one side, thus increasing the applicability and flexibility of the switching between a horizontal screen and a vertical screen.

### CROSS-REFERENCE TO RELATED APPLICATIONS

This application is a continuation of International Application No. PCT/2010/078864, filed on Nov. 18, 2010, which claims priority to Chinese Patent Application No. 201010144597.9, filed with the Chinese Patent Office on Apr. 8, 2010, both of which are hereby incorporated by reference in its entireties.

### FIELD OF THE INVENTION

The present invention relates to the field of mobile terminal technologies, and in particular, to a method for switching the touch screen of a mobile terminal between a horizontal screen and a vertical screen and a mobile terminal.

### BACKGROUND OF THE INVENTION

Capacitive touch screens are extensively used in mobile terminals, and especially in high-end mobile terminals.

The capacitive touch screen uses conductivity of the human body. When a finger touches the screen, a part of charges are absorbed from the capacitive touch screen. The distance between a touch point and four corners of a square touch screen determines how many charges are absorbed from the four corners. The longer the distance is, the fewer charges are absorbed; the shorter the distance is, the more charges are absorbed. Therefore, the specific position of the touch point is obtained by judging the distance between the touch point and the four corners. In addition, multipoint touching may be implemented on this capacitive touch screen, that is, if multiple points on the screen are touched at the same time, the device can determine the positions of the touch points.

The high-end mobile terminals using this capacitive touch screen have fewer and fewer buttons and even have no ordinary buttons. Seen from a front face, a high-end mobile terminal is basically a large mirror, and a touch screen almost occupies the whole area.

With the development of technologies, a gravity sensing chip is added to the high-end mobile terminal to implement automatic switching between a horizontal screen and a vertical screen. The mobile terminal calculates the current placement form of the mobile terminal by using the gravity sensing chip to determine whether to display a screen in the form of a horizontal screen or vertical screen.

In the process of implementing the present invention, the inventor discovers that the prior art has at least the following problems: the flexibility of the switching between a horizontal screen and a vertical screen is poor; for example, when a user lies on one side, the mobile terminal calculates, by using the gravity sensing chip, that the mobile terminal is placed horizontally, and then displays the screen in the form of a horizontal screen. Therefore, the switching between a horizontal screen and a vertical screen fails to meet requirements.

### SUMMARY OF THE INVENTION

Embodiments of the present invention provide a method for switching the touch screen of a mobile terminal between a horizontal screen and a vertical screen and a mobile terminal, so as to increase the flexibility of the switching between a horizontal screen and a vertical screen.

An embodiment of the present invention provides a method for switching the touch screen of a mobile terminal between a horizontal screen and a vertical screen, including:

according to a value of the acceleration of gravity in a direction vertical to the screen of the mobile terminal, determining whether the operation mode of the mobile terminal is a normal operation mode or a recumbent operation mode;

determining, according to a determined operation mode, a criterion for switching between a horizontal screen and a vertical screen; and

performing the switching between a horizontal screen and a vertical screen according to the criterion.

An embodiment of the present invention also provides a mobile terminal, including:

an operation mode determining module, configured to: according to the value of acceleration of gravity in a direction vertical to the screen of the mobile terminal, determine whether the operation mode of the mobile terminal is a normal operation mode or a recumbent operation mode;

a switching criterion determining module, configured to determine, according to a determined operation mode, a criterion for switching between horizontal screen and vertical screen; and

a switching module, configured to perform the switching between horizontal screen and vertical screen according to the criterion.

According to the technical solutions provided in the above embodiments of the present invention, the operation mode of the mobile terminal is determined, and a criterion for switching between a horizontal screen and a vertical screen is determined according to the operation mode, which solves the problem that the switching between a horizontal screen and a vertical screen cannot meet requirements when a user lies on one side, thus increasing the flexibility of the switching between a horizontal screen and a vertical screen.

### BRIEF DESCRIPTION OF THE DRAWINGS

To illustrate the technical solutions of the present invention more clearly, the accompanying drawings for describing the embodiments of the present invention are briefly introduced in the following. Obviously, the accompanying drawings are merely exemplary embodiments, and persons skilled in the art may derive other drawings from the accompanying drawings without creative efforts.

FIG. 1 is a flowchart of a method for switching the touch screen of a mobile terminal between a horizontal screen and a vertical screen according to an embodiment of the present invention;

FIG. 2 is a schematic diagram illustrating the principle of a three-axis gravity sensing chip in a method for switching the touch screen of a mobile terminal between a horizontal screen and a vertical screen according to an embodiment of the present invention;

FIG. 3 is a schematic diagram of holding areas in a method for switching the touch screen of a mobile terminal between a horizontal screen and a vertical screen according to an embodiment of the present invention; and

FIG. 4 is a schematic structural diagram of a mobile terminal according to an embodiment of the present invention.

### DETAILED DESCRIPTION OF THE EMBODIMENTS

The technical solutions of the embodiments of the present invention are hereinafter described clearly and completely with reference to the accompanying drawings in the embodiments of the present invention. Evidently, the described embodiments are only some exemplary embodiments of the present invention, rather than all embodiments of the present invention. All other embodiments obtained by persons skilled in the art based on the embodiments of the present invention without creative efforts shall fall within the protection scope of the present invention.

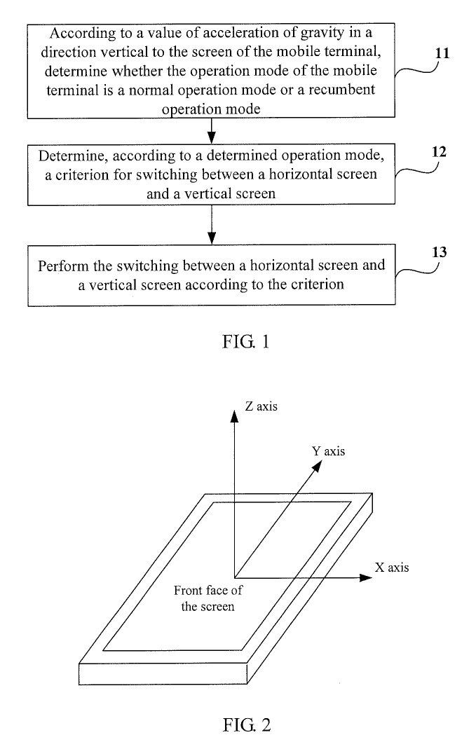

FIG. 1 is a flowchart of a method for switching the touch screen of a mobile terminal between a horizontal screen and a vertical screen according to an embodiment of the present invention. The method includes:

Step 11: According to a value of the acceleration of gravity in a direction vertical to the screen of the mobile terminal, determine whether the operation mode of the mobile terminal is a normal operation mode or a recumbent operation mode.

For example, if the value of the acceleration of gravity in the direction vertical to the screen of the mobile terminal is smaller than 0, the operation mode of the mobile terminal is determined to be the normal operation mode; if the value of the acceleration of gravity in the direction vertical to the screen of the mobile terminal is greater than or equal to 0, the operation mode of the mobile terminal is determined to be the recumbent operation mode.

The principle of a three-axis gravity sensing chip used in a mobile terminal, for example, a handset, is shown in FIG. 2, where the gravity in the X axis, Y axis, and Z axis is determined. The X axis and Y axis are parallel with the plane of the handset. The X axis refers to the direction of width of the mobile terminal, the Y axis refers to the direction of length of the mobile terminal, and the Z axis is vertical to the plane of the handset, that is, the Z axis refers to a direction vertical to the screen of the mobile terminal. When the handset is placed horizontally with a front face up, the values of the acceleration of gravity reported in the X axis, Y axis, and Z axis are 0, 0, and −9.8 (the acceleration of gravity is 9.8) respectively. When the handset is overturned, the data of the X axis, Y axis, and Z axis may change accordingly.

In this embodiment, the operation mode of the mobile terminal is divided into the normal operation mode and the recumbent operation mode to meet requirements for the switching between a horizontal screen and a vertical screen in more operation scenarios, thus increasing the flexibility of the switching between a horizontal screen and a vertical screen.

The normal operation mode means that a user uses the mobile terminal when the user sits down or stands. In the normal operation mode, the user overlooks the screen of the mobile terminal, the screen faces up, and the value of the Z axis is negative, that is, smaller than 0. The recumbent operation mode means that the user uses the mobile terminal when the user lies down. In this mode, three cases are involved: the user uses the mobile terminal when lying on the back, the user uses the mobile terminal when lying on the left side, and the user uses the mobile terminal when lying on the right side. If the user uses the mobile terminal when lying on the back, the screen of the handset faces down, and the value of the Z axis is positive, that is, greater than 0; if the user uses the mobile terminal when lying on the left side or on the right side, the screen of the handset is basically parallel with a vertical direction, and the value of the Z axis is close to 0.

Therefore, before whether the screen of the mobile terminal is a horizontal screen or a vertical screen is determined, whether a current mode is the normal operation mode or the recumbent operation mode is determined. Specifically, if the value of the Z axis is negative, and the angle between the Z axis and the vertical direction is smaller than a threshold angle, for example, 45 degrees, that is, the mobile terminal is basically in a face-up holding manner a current operation mode is determined to be the normal operation mode; if the value of the Z axis is positive and the angle between the Z axis and the vertical direction is smaller than a threshold angle, for example, 45 degrees, the current mode is determined to be the recumbent operation mode. The threshold angle is set to avoid the triggering of the switching between modes continuously in a critical case. A wide intermediate transition zone is set. In this transition zone, no mode switching is performed, and a previous mode is maintained.

Step 12: Determine, according to a determined operation mode, a criterion for switching between a horizontal screen and a vertical screen.

When the operation mode of the mobile terminal is determined to be the normal operation mode, an ordinary criterion for switching between a horizontal screen and a vertical screen is used. That is, the criterion for the vertical screen is as follows: the value of the X axis is close to 0, and the value of the Y axis is greater than a threshold value, for example 6. The criterion for the horizontal screen is as follows: the value of the Y axis is close to 0, and the value of the X axis is greater than a threshold value, for example 6. The switching between horizontal screen and vertical screen is performed when related angle requirements are met, and a previous screen mode of a horizontal screen or a vertical screen is maintained in other cases.

If the operation mode is the recumbent operation mode, the criterion for switching between a horizontal screen and a vertical screen is determined to be a criterion in the recumbent operation mode. Specifically, the recumbent operation mode may be further divided into lying on the back, lying on the right side, and lying on the left side. The features in the case of lying on the back are as follows: the values of the X axis and the Y axis are relatively small, and the handset is held with the face down. In this case, the switching between a horizontal screen and a vertical screen may be performed according to the specific values of the X axis and the Y axis. For example, if the angle between the X axis and a horizontal plane is greater than 30 degrees (the angle may be adjusted freely) and the Y axis is closer to 0, the screen mode of the mobile terminal is switched to the horizontal screen; if the angle between the Y axis and the horizontal plane is greater than 30 degrees and the X axis is closer to 0, the screen mode of the mobile terminal is switched to the vertical screen.

In the case of lying on the right side, the criterion for the horizontal screen is as follows: the Y axis is closer to a −G value (−9.8), and the X axis is closer to 0; the criterion for the vertical screen is as follows: the X axis is close to a G value, and the Y axis is close to 0.

In the case of lying on the left side, the criterion for the horizontal screen is as follows: the Y axis is closer to a G value, and the X axis is closer to 0; the criterion for the vertical screen is as follows: the X axis is close to a −G value, and the Y axis is close to 0.

Step 13: Perform the switching between a horizontal screen and a vertical screen according to the criterion. Specifically, if the value of the acceleration of gravity of the mobile terminal in an X axis direction is close to 0 and the value of the acceleration of gravity of the mobile terminal in a Y axis direction is −9.8, the display screen of the mobile terminal is switched to the horizontal screen; if the value of the acceleration of gravity of the mobile terminal in the Y axis direction is close to 0 and the value of the acceleration of gravity of the mobile terminal in the X axis direction is 9.8, the display screen of the mobile terminal is switched to the vertical screen; if the value of the acceleration of gravity of the mobile terminal in the X axis direction is close to 0 and the value of the acceleration of gravity of the mobile terminal in the Y axis direction is 9.8, the display screen of the mobile terminal is switched to the horizontal screen; if the value of the acceleration of gravity of the mobile terminal in the Y axis direction is close to 0 and the value of the acceleration of gravity of the mobile terminal in the X axis direction is −9.8, the display screen of the mobile terminal is switched to the vertical screen.

According to the technical solution provided in this embodiment, in view of the fact that the holding positions of the handset in some states are nearly the same in the recumbent operation mode and the normal operation mode, whether the current mode of the mobile terminal is the normal operation mode or the recumbent operation mode may be determined first. In this way, a previous operation mode is maintained unless the operation mode of the mobile terminal is changed to meet the criterion for another operation mode. For example, the criterion for the recumbent operation mode is that the Z axis is positive and that the angle between the Z axis and the vertical direction is smaller than a threshold angle, for example, 45 degrees. Therefore, if the current operation mode of the mobile terminal is the recumbent operation mode, the mobile terminal maintains the recumbent operation mode unless the criterion for the normal operation mode is met, that is, the Z axis is negative and the angle between the Z axis and the vertical direction is smaller than a threshold angle, for example, 45 degrees, or the mobile terminal is close to the face-up holding mode. Therefore, if a user wants to use the mobile terminal in the case of lying on one side, the user may turn down the screen of the mobile terminal, and then use the mobile terminal after the mobile terminal is switched to the recumbent operation mode. In this way, it is ensured that the user's requirement for using the vertical screen can still be met when the user lies on one side, thus avoiding a conflict with the requirement for using the horizontal screen in the normal operation mode and increasing the flexibility of the switching between a horizontal screen and a vertical screen.

If the operation mode of the mobile terminal is determined to be the recumbent operation mode, the method for switching the touch screen of a mobile terminal between a horizontal screen and a vertical screen according to an embodiment of the present invention further includes:

displaying a holding area on the touch screen of the mobile terminal, where the number of the holding area is one or above.

When the current mode of the mobile terminal is determined to be the recumbent operation mode, the front face of the screen of the mobile terminal is close to facing down vertically, so that it is hard for the user to operate the mobile terminal with a single hand. In this case, a holding point or a holding area is displayed as a dotted box on the screen of the mobile terminal, which ensures that the user holds the mobile terminal conveniently and does not trigger other processing operations of the touch screen. The mobile terminal maintains a previous state, without affecting other normal processing operations of the touch screen.

The displaying a holding area on the touch screen of the mobile terminal may include:

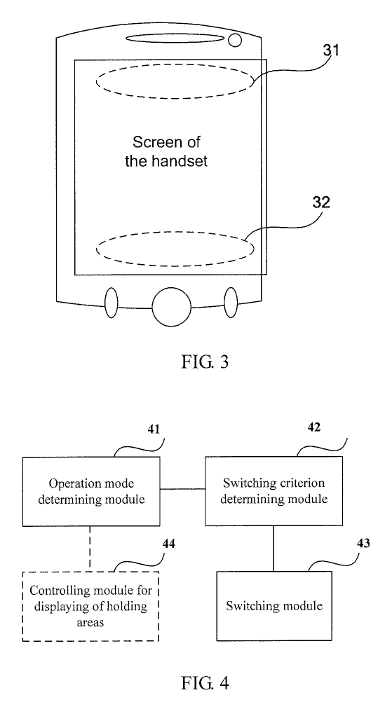

displaying multiple holding areas on the touch screen of the mobile terminal, so that the user may choose an area to hold. That is, the screen of the mobile terminal may provide multiple holding areas. As shown in FIG. 3, the screen of the handset displays a first area 31 and a second area 32, and the user may choose to hold either one of the two areas. If the user wants to operate the icon in the second area 32, the user may switch to hold the first area by using the multipoint touch function of a capacitive touch screen.

If there are multiple holding areas and any one of the holding areas is not held by the user, the mobile terminal displays all holding areas; if there are multiple holding areas and any one of the holding areas is held by the user, the mobile terminal stops displaying other areas not held by the user.

The specific process of displaying the holding area shown in FIG. 3 by the handset may include: after determining that the current operation mode of the handset is the recumbent operation mode, adding holding points to help the user to hold the handset, and displaying optional holding areas on the screen of the handset. The holding areas may be set according to an actual situation, for example, the structure and shape of the handset, and the convenience of holding the handset by the user.

After the user holds one of the multiple holding areas, the method for switching the touch screen of the mobile terminal between a horizontal screen and a vertical screen according to an embodiment of the present invention may further include:

stopping displaying other areas of the multiple holding areas. That is, when the user touches the holding area with a finger and holds the handset, the handset software determines, according to the position of the touch point, that the user touches the holding area, and thus ignores a touch screen event. In addition, the dotted lines of other holding areas displayed on the screen disappear. When the user uses another finger to operate positions other than the holding area on the touch screen, handset software determines that the touch screen event is an event triggered by a second point, and processes the event according to a normal case.

After the user's finger leaves the holding area, the method for switching the touch screen of the mobile terminal between a horizontal screen and a vertical screen according to an embodiment of the present invention may further include:

re-displaying other areas of the multiple holding areas. That is, if the user's finger leaves the touch screen, the dotted lines of the touch areas shown in FIG. 3 appears again, so that the user may change a holding area.

The area held by the user among the multiple holding areas may move along with the movement of the position held by the user. That is, after the user holds an area, the user may drag the area freely to a position desired by the user.

FIG. 4 is a schematic structural diagram of a mobile terminal according to an embodiment of the present invention. The mobile terminal includes an operation mode determining module 41, a switching criterion determining module 42, and a switching module 43. The operation mode determining module 41 is configured to: according to the value of acceleration of gravity in a direction vertical to the screen of the mobile terminal, determine whether the operation mode of the mobile terminal is a normal operation mode or a recumbent operation mode. For example, the operation mode determining module 41 may be configured to: if the operation mode is the recumbent operation mode, determine that the criterion for the switching between a horizontal screen and a vertical screen is a criterion in the recumbent operation mode. The switching criterion determining module 42 is configured to determine, according to a determined operation mode, a criterion for switching between a horizontal screen and a vertical screen. For example, the switching criterion determining module 42 may be configured to: if the operation mode is the recumbent operation mode, determine that the criterion for the switching between a horizontal screen and a vertical screen is a criterion in the recumbent operation mode. Details are disclosed in the above step 12. The switching module 43 is configured to perform the switching between a horizontal screen and a vertical screen according to the criterion. For example, the switching module 43 is configured to: if the angle between the direction of width of the mobile terminal and a horizontal plane is greater than a preset angle and the angle between the direction of length of the mobile terminal and the horizontal plane is close to 0, switch the display screen of the mobile terminal to the horizontal screen; if the angle between the direction of length of the mobile terminal and the horizontal plane is greater than a preset angle and the angle between the direction of width of the mobile terminal and the horizontal plane is close to 0, switch the display screen of the mobile terminal to the vertical screen; if the value of the acceleration of gravity of the mobile terminal in the direction of width is close to 0 and the value of the acceleration of gravity of the mobile terminal in the direction of length is close to −9.8, switch the display screen of the mobile terminal to the horizontal screen; if the value of the acceleration of gravity of the mobile terminal in the direction of length is close to 0 and the value of the acceleration of gravity of the mobile terminal in the direction of width is close to 9.8, switch the display screen of the mobile terminal to the vertical screen; if the value of the acceleration of gravity of the mobile terminal in the direction of width is close to 0 and the value of the acceleration of gravity of the mobile terminal in the direction of length is close to 9.8, switch the display screen of the mobile terminal to the horizontal screen; if the value of the acceleration of gravity of the mobile terminal in the direction of length is close to 0 and the value of the acceleration of gravity of the mobile terminal in the direction of width is close to −9.8, switch the display screen of the mobile terminal to the vertical screen.

In this embodiment, the mobile terminal determines the operation mode of the mobile terminal, and determines, according to the operation mode, a criterion for the switching between a horizontal screen and a vertical screen, which solves the problem that the user's requirement for switching between a horizontal screen and a vertical screen cannot be met when the user lies on one side, thus increasing the flexibility of the switching between a horizontal screen and a vertical screen.

The mobile terminal provided in this embodiment of the present invention may further include a controlling module 44 for displaying of a holding area. The controlling module 44 for displaying of a holding area is configured to: if the operation mode determining module determines that the operation mode of the mobile terminal is the recumbent operation mode, display a holding area on the touch screen of the mobile terminal, where the number of the holding area is one or above.

The controlling module 44 for displaying of a holding area may include a first submodule of the controlling module for displaying of a holding area, configured to: when there are multiple holding areas and any one of the holding areas is not held by a user, display all holding areas; when there are multiple holding areas and any one of the holding areas is held, stop displaying the holding areas not held by the user.

The controlling module 44 for displaying of a holding area may include a second submodule of the controlling module for displaying of a holding area, configured to control an area held by the user among the multiple holding areas to move along with the movement of the position held by the user. That is, after the user holds an area, the user may drag the area freely to a position desired by the user.

In the above method and terminal provided in embodiments of the present invention, the operation mode of the mobile terminal is differentiated, which solves the problem of the prior art where the requirement of a user for switching between a horizontal screen and a vertical screen cannot be met when the user lies on the back. For example, when the user uses the handset in the case of lying on the right side, the actual state of the handset is like the state of the handset held vertically by the user in the case of standing (or sitting down). Whether the operation mode of the mobile terminal is a recumbent operation mode is determined first, which solves the problem that the user's requirement for using the horizontal screen cannot be met when the handset is automatically switched to the vertical screen. Furthermore, the holding area is displayed, which solves the problem that it is hard for the user to operate the handset with a single hand due to the lack of an effective holding position of a large touch-screen handset when the user lies on the back. Because the front face of the handset is almost covered by the touch screen entirely, the gravity of the handset may be placed in the center of a hand in the normal operation mode, which facilitates the holding of the handset. However, in the recumbent operation mode, the handset can only be held by using the four sides of the handset, which brings about inconvenience to a single-hand operation on the handset. If a support point is added to the front face of the handset, the touch screen may be wrongly triggered and a misoperation may occur. Displaying the holding area on the screen ensures that the user can still hold the handset effectively when the user lies on the back, which avoids misoperations due to improper holding of the handset.

Those skilled in the art may understand that all or a part of the steps of the method according to the embodiments of the present invention may be implemented by a program instructing relevant hardware. The program may be stored in a computer readable storage medium. When the program runs, the steps of the method according to the embodiments of the present invention are performed. The storage medium may be any medium capable of storing program codes, such as a ROM, a RAM, a magnetic disk, or a CD-ROM.

Finally, it should be noted that the foregoing embodiments are merely provided for describing the technical solutions of the present invention, but not intended to limit the present invention. It should be understood by a person skilled in the art that although the present invention are described in detail with reference to the embodiments, modifications may be made to the technical solutions described in each of the embodiments, or equivalent replacements may be made to some technical features in the technical solutions, as long as such modifications or replacements do not cause the essence of corresponding technical solutions to depart from the spirit and scope of the technical solutions in each of the embodiments of the present invention.

What is claimed is:

1. A method for switching a touch screen of a mobile terminal between a horizontal screen and a vertical screen, comprising:
according to a value of acceleration of gravity in a direction vertical to a screen of the mobile terminal, determining whether an operation mode of the mobile terminal is a normal operation mode or a recumbent operation mode;
determining, according to a determined operation mode, a criterion for switching between a horizontal screen and a vertical screen; and
performing the switching between a horizontal screen and a vertical screen according to the criterion.

2. The method for switching a touch screen of a mobile terminal between a horizontal screen and a vertical screen according to claim 1, wherein the determining, according to a determined operation mode, a criterion for switching between a horizontal screen and a vertical screen comprises:
if the operation mode is a recumbent operation mode, determining that the criterion for switching between a horizontal screen and a vertical screen is a criterion in the recumbent operation mode.

3. The method for switching a touch screen of a mobile terminal between a horizontal screen and a vertical screen according to claim 2, wherein the performing the switching between a horizontal screen and a vertical screen according to the criterion comprises:
if an angle between a direction of width of the mobile terminal and a horizontal plane is greater than a preset angle and an angle between a direction of length of the mobile terminal and the horizontal plane is close to 0, switching a display screen of the mobile terminal to the horizontal screen;
if the angle between the direction of length of the mobile terminal and the horizontal plane is greater than a preset angle and the angle between the direction of width of the mobile terminal and the horizontal plane is close to 0, switching the display screen of the mobile terminal to the vertical screen;
if a value of the acceleration of gravity of the mobile terminal in the direction of width is close to 0 and a value of the acceleration of gravity in the direction of length is close to −9.8, switching the display screen of the mobile terminal to the horizontal screen;
if the value of the acceleration of gravity of the mobile terminal in the direction of length is close to 0 and the value of the acceleration of gravity in the direction of width is close to 9.8, switching the display screen of the mobile terminal to the vertical screen;
if the value of the acceleration of gravity of the mobile terminal in the direction of width is close to 0 and the value of the acceleration of gravity in the direction of length is close to 9.8, switching the display screen of the mobile terminal to the horizontal screen; and
if the value of the acceleration of gravity of the mobile terminal in the direction of length is close to 0 and the value of the acceleration of gravity in the direction of width is close to −9.8, switching the display screen of the mobile terminal to the vertical screen.

4. The method for switching a touch screen of a mobile terminal between a horizontal screen and a vertical screen according to claim 1, wherein if determining that the operation mode of the mobile terminal is a recumbent operation mode, the method further comprises:
displaying a holding area on the touch screen of the mobile terminal, wherein the number of the holding area is one or above.

5. The method for switching a touch screen of a mobile terminal between a horizontal screen and a vertical screen according to claim 2 wherein if determining that the operation mode of the mobile terminal is a recumbent operation mode, the method further comprises:
displaying a holding area on the touch screen of the mobile terminal, wherein the number of the holding area is one or above.

6. The method for switching a touch screen of a mobile terminal between a horizontal screen and a vertical screen according to claim 3, wherein if determining that the operation mode of the mobile terminal is a recumbent operation mode, the method further comprises:
displaying a holding area on the touch screen of the mobile terminal, wherein the number of the holding area is one or above.

7. The method for switching a touch screen of a mobile terminal between a horizontal screen and a vertical screen according to claim 4, wherein when there are multiple holding areas and any one of the multiple holding areas is not held by a user, all the holding areas are displayed; when there are multiple holding areas and any one of the multiple areas is held by the user, other areas not held by the user are not displayed.

8. The method for switching a touch screen of a mobile terminal between a horizontal screen and a vertical screen according to claim 4, wherein when there are multiple holding areas, an area held by the user moves along with movement of a position held by the user

9. A mobile terminal, comprising:
an operation mode determining module, configured to: according to a value of acceleration of gravity in a direction vertical to a screen of the mobile terminal, determine whether an operation mode of the mobile terminal is a normal operation mode or a recumbent operation mode;
a switching criterion determining module, configured to determine, according to a determined operation mode, a criterion for switching between a horizontal screen and a vertical screen; and
a switching module, configured to perform the switching between a horizontal screen and a vertical screen according to the criterion.

10. The mobile terminal according to claim 9, wherein the operation mode determining module is configured to: if the operation mode is a recumbent operation mode, determine that the criterion for switching between a horizontal screen and a vertical screen is a criterion in the recumbent operation mode.

11. The mobile terminal according to claim 10, wherein the switching module is configured to: if an angle between a direction of width of the mobile terminal and a horizontal plane is greater than a preset angle and an angle between a direction of length of the mobile terminal and the horizontal plane is close 0, switch a display screen of the mobile terminal to the horizontal screen; and
if the angle between the direction of length of the mobile terminal and the horizontal plane is greater than a preset angle and the angle between the direction of width of the mobile terminal and
the horizontal plane is close to 0, switch the display screen of the mobile terminal to the vertical screen;
if a value of the acceleration of gravity of the mobile terminal in the direction of width is close to 0 and a value of the acceleration of gravity in the direction of length is close to −9.8, switch the display screen of the mobile terminal to the horizontal screen;
if the value of the acceleration of gravity of the mobile terminal in the direction of length is close to 0 and the value of the acceleration of gravity in the direction of width is close to 9.8, switch the display screen of the mobile terminal to the vertical screen;
if the value of the acceleration of gravity of the mobile terminal in the direction of width is close to 0 and the value of the acceleration of gravity in the direction of length is close to 9.8, switch the display screen of the mobile terminal to the horizontal screen; and
if the value of the acceleration of gravity of the mobile terminal in the direction of length is close to 0 and the value of the acceleration of gravity in the direction of width is close to −9.8, switch the display screen of the mobile terminal to the vertical screen.

12. The mobile terminal according to claim 7, further comprising:
a controlling module for displaying of a holding area, configured to: if the operation mode determining module determines that the operation mode of the mobile terminal is a recumbent operation mode, display a holding area on the touch screen of the mobile terminal, wherein the number of the holding area is one or above.

13. The mobile terminal according to claim 12, wherein the controlling module for displaying of a holding area comprises a first submodule of the controlling module for displaying of a holding area, configured to: when there are multiple holding areas and any one of the holding areas is not held by a user, display all holding areas; and when there are multiple holding areas and any one of the holding areas is held, stop displaying the holding areas not held by the user.

14. The mobile terminal according to claim 12, wherein the controlling module for displaying of a holding area comprises a second submodule of the controlling module for displaying of a holding area, configured to control an area held by a user among the multiple holding areas, so that the area moves along with movement of a position held by the user.
